(19) United States
(12) Patent Application Publication
(10) Pub. No.: US 2013/0160359 A1
(43) Pub. Date: Jun. 27, 2013

(54) MONITORING PLATFORM, STRUCTURE AND MONITORING SYSTEM OF PLANTING BED

(71) Applicants: Ta-Te Lin, Taipei (TW); Wan-Lin Hu, Taipei (TW); Chang-Chih Liu, Taipei (TW); Tai-Hsien Ou-Yang, Taipei (TW); Tsung-Cheng Lai, Taipei (TW)

(72) Inventors: Ta-Te Lin, Taipei (TW); Wan-Lin Hu, Taipei (TW); Chang-Chih Liu, Taipei (TW); Tai-Hsien Ou-Yang, Taipei (TW); Tsung-Cheng Lai, Taipei (TW)

(73) Assignee: National Taiwan University, Taipei (TW)

(21) Appl. No.: 13/352,463

(22) Filed: Jan. 18, 2012

(30) Foreign Application Priority Data
Dec. 22, 2011 (TW) 100147981

(51) Int. Cl. H04N 7/18; A01G 1/00

(52) U.S. Cl. 47/33; 348/159; 348/E07.085

(57) ABSTRACT

A structure of a planting bed includes at least a work platform, a plurality of first and second supporting rods, a sliding track and an image capture apparatus. The first work platform is disposed on a work plane for supporting a plurality of plants. The first supporting rods each extend in a first direction. The second supporting rods are disposed on the work plane and around the work platform to support the work platform on the work plane, and each are connected to two adjacent first supporting rods. The sliding track is disposed on a monitoring plane and extends in a second direction. The sliding structure extends in a third direction and an end thereof is disposed on the sliding track. The image capture apparatus is installed to the sliding structure for capturing images at different positions on the work platform while the sliding structure is being driven to slide.

### TECHNICAL FIELD

The present invention relates to a monitoring platform, a structure and a monitoring system, and more particularly to a monitoring platform, a structure and a monitoring system of planting bed.

### BACKGROUND

Compared with the traditional or open-air plant cultivation ways, plant factories can highly control the environmental conditions for crop plants' growth. That is, through providing a suitable environment, plant factories can have a higher crop yield and crops with a high quality. Generally, different plants in different growing phases may need different growing environments. So, through having plants grown under different environmental conditions so as to collect growth data and analyze growth models, plant factories can establish a plant environmental control strategy for the plants' growth. In addition, plant factories can get a better understanding of the impacts of the environmental factors on the crop physiology through analyzing these growth data and growth models.

In plant factories, plants' growth is affected by many environmental factors, such as temperatures, humidity, illuminations and nutrient solutions. To perform a plant analysis and establish plant growth models so as to improve the environment for plants' growth, it is necessary to measure and record the plants' growth conditions under different experimental factors during the growth process. However, most of the conventional means for the measurement of indicators of plants' growth, such as dry weights, leaf areas and plant heights, are destructive. Therefore, it is necessary to provide an automatic non-destructive monitoring system for a planting bed.

### SUMMARY OF EMBODIMENTS

Therefore, one object of the present invention is to provide a monitoring platform and a monitoring system of a planting bed for monitoring the plants' growth conditions.

Another object of the present invention is to provide a structure of a planting bed capable of being monitored for plants' growth conditions.

The present invention provides a monitoring platform adapted to use with a planting bed. The planting bed is constituted by a work platform disposed on a work plane and for supporting a plurality of plants thereon. The monitoring platform includes a first sliding track, a sliding structure, an actuator and an image capture apparatus. The first sliding track is disposed on a monitoring plane and extending in a first predetermined direction. The monitoring plane and the work plane are parallel to each other in a first visible range and have a first predetermined distance therebetween. The sliding structure extends in a second predetermined direction and a first end thereof is disposed on the first sliding track. The sliding structure through the first end thereof slides along the first sliding track. The actuator is configured to drive the sliding structure to slide along the first sliding track. The image capture apparatus is installed to the sliding structure and configured to capture images at different positions on the work platform while the sliding structure is being driven to slide.

The present invention further provides a structure of a planting bed, which includes at least a first work platform, a plurality of first supporting rods, a plurality of second supporting rods and a monitoring platform. The first work platform is disposed on a first work plane for supporting a plurality of plants. The first supporting rods each extend in a first predetermined direction. The second supporting rods are disposed on the first work plane and around the first work platform so as to support the first work platform on the first work plane, and the second supporting rods each are connected to two adjacent first supporting rods. The monitoring platform, supported fixedly by the first supporting rods, includes a first sliding track, a sliding structure and an image capture apparatus. The first sliding track is disposed on a first monitoring plane, extends in a second predetermined direction and is supported fixedly by a portion of the first supporting rods, wherein the first monitoring plane and the work plane are parallel to each other in a visible range and have a first predetermined distance therebetween. The sliding structure extends in a third predetermined direction and a first end thereof is disposed on the first sliding track, wherein the sliding structure through the first end thereof slides along the first sliding track. The image capture apparatus is installed to the sliding structure for capturing a plurality of images at different positions on the work platform while the sliding structure is being driven to slide.

In an embodiment of the present invention, the structure further includes an environmental information detecting unit installed to the sliding structure for collecting growing environmental information of the planting bed.

The present invention further provides a monitoring system adapted to use with a planting bed. The planting bed is constituted by a work platform disposed on a work plane and for supporting a plurality of plants thereon. The monitoring system includes a supporting bracket, a sliding module, an actuator and an image capture apparatus. The supporting bracket is disposed on the work platform for defining a monitoring plane opposite to the work plane, wherein the monitoring and work planes are parallel to each other in a visible range and have a predetermined distance therebetween. The sliding module is supported by the supporting bracket and includes a sliding structure. The actuator is electrically connected to the sliding module for driving the sliding structure to slide forwardly and backwardly on the monitoring plane in a predetermined direction. The image capture apparatus is installed to the sliding structure for capturing a plurality of images of the work platform from different positions on the monitoring plane while the sliding structure is driven by the actuator to slide in the predetermined direction.

In summary, because an image capture apparatus is installed to a sliding structure capable of sliding forwardly and backwardly in a predetermined direction, so a planting bed can be monitored completely through adopting one image capture apparatus only in the present invention. In addition, different types of environmental information associated with the planting bed can be collected due to the sliding structure is further equipped with an environmental information detecting unit.

### BRIEF DESCRIPTION OF THE DRAWINGS

The above embodiments will become more readily apparent to those ordinarily skilled in the art after reviewing the following detailed description and accompanying drawings, in which:

FIG. 1 is a three-dimensional view of a structure of a planting bed in accordance with an embodiment of the present invention; and

FIG. 2 is a block view of a monitoring system in accordance with an embodiment of the present invention.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

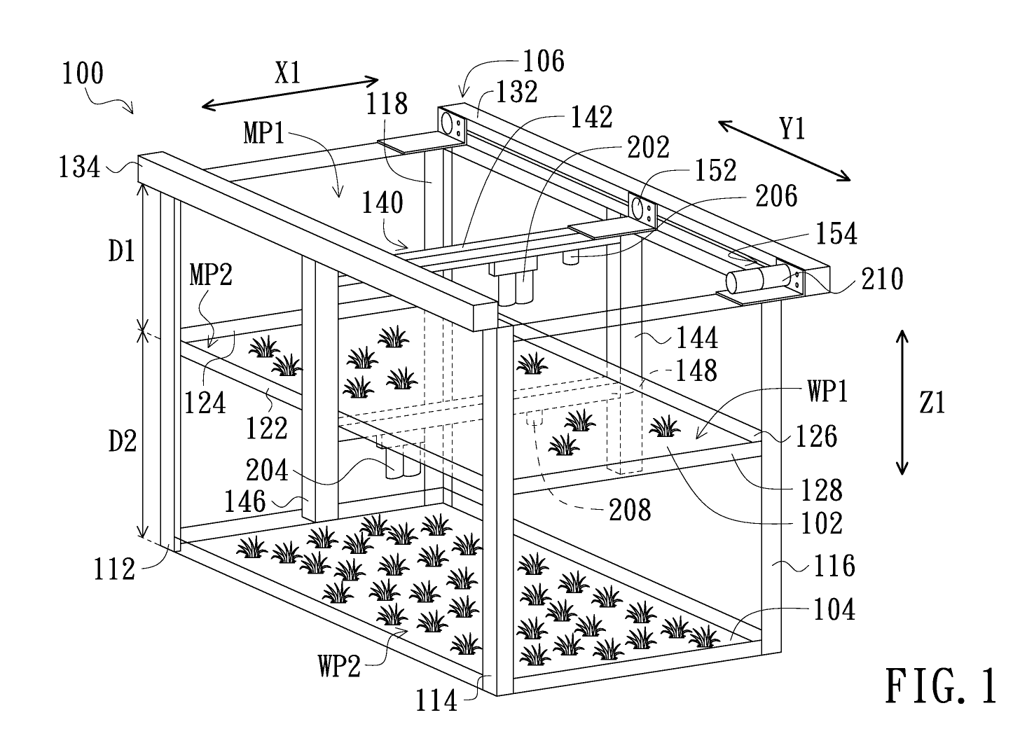

FIG. 1 is a three-dimensional (3D) view of a structure of a planting bed in accordance with an embodiment of the present invention. As shown, the planting bed 100 includes a work plane WP1 and a monitoring plane MP1 opposite to the work plane WP1. On the work plane WP1, a work platform 102 is disposed to support plants. Moreover, in this embodiment, the monitoring plane MP1 and the work plane WP1 are, without a limitation, parallel to each other in a visible range.

The planting bed 100 may have a multi-layer or structure a single-layer structure. To get a clear understanding of the present invention, the planting bed 100 is exemplified by a multi-layer (specifically, a two-layer) structure. Accordingly, the planting bed 100 has two work planes WP1, WP2 respectively defined at two different heights, two work platforms 102, 104 respectively disposed on the two work planes WP1, WP2, and two monitoring planes MP1, MP2 respectively opposite to the two work planes WP1, WP2; wherein it is noted that the monitoring plane MP2 and the work plane WP1 actually are defined at a same plane. In addition, the work plane WP1 and the corresponding monitoring plane MP1 have a predetermined distance D1 therebetween; the work plane WP2 and the corresponding monitoring plane MP2 have a predetermined distance D2 therebetween; and the predetermined distances D1, D2 are not necessary to have a same value.

To make the description of the present invention concise and neat, hereafter only one layer of the two-layer structure, constituted by the work plane WP1, the work platform 102 and the monitoring plane MP1, in the planting bed 100 will be used for the illustration of the present invention. However, those ordinarily skilled in the art can easily develop a planting bed with a multi-layer structure from a single-layer structure based on the following description.

As shown in FIG. 1, the planting bed 100 further includes a supporting bracket, which is constituted by first supporting rods 112, 114, 116 and 118 and second supporting rods 122, 124, 126 and 128. The first supporting rods 112, 114, 116 and 118 are arranged to extend in a predetermined direction Z1. The second supporting rod 122, 124, 126 and 128 are disposed on the work plane WP1 and around the work platform 102 so as to support the work platform 102 on the work plane WP1. In addition, the second supporting rods 122, 124, 126 and 128 each are disposed to connect two adjacent first supporting rods; for example, the second supporting rod 122 two ends thereof are connected to the two adjacent first supporting rods 112, 114, respectively.

As shown in FIG. 1, in particular, the planting bed 100 of this embodiment further includes at least one monitoring platform 106. The monitoring platform 106 includes at least one sliding track 132, which is disposed on the monitoring plane MP1, extending in a predetermined direction Y1, and supported by the first supporting rods 116, 118; wherein the predetermined direction Y1 is generally perpendicular to the predetermined direction Z1. In this embodiment, the sliding track 132 is, for example, an electrical sliding track and includes a moving part 152 and a groove 154. The groove 154 extends in the predetermined direction Y1, and the moving part 152 is engaged and movable in the groove 154. And thus, the moving part 152 can slide forwardly and backwardly in the predetermined direction Y1 along the groove 154.

In addition, the monitoring platform 106 further includes a sliding structure 140, which is capable of sliding along the sliding track 132. Specifically, the sliding structure 140 at least includes a primary sliding part 142. The primary sliding part 142 is disposed on the monitoring plane MP1, extending in a predetermined direction X1, and one end thereof connected to the moving part 152 of the sliding track 132; wherein the predetermined direction X1 is generally perpendicular to each of the predetermined directions Y1, Z1. Therefore, through a driving of the moving part 152, the sliding structure 140 as well as the primary sliding part 142 can slide forwardly and backwardly in the predetermined direction Y1 along the sliding track 132.

An image capture apparatus 202 is installed to the primary sliding part 142. And thus, the image capture apparatus 202 can capture images of the work platform 102 on the work plane WP1 from different positions on the monitoring plane MP1 while the primary sliding part 142 is driven by the moving part 152 to slide forwardly and backwardly in the predetermined direction Y1.

It is noted that the sliding structure 140 further includes a pair of connecting part 144, 146 and at least one secondary sliding part 148 if the planting bed 100 has a multi-layer structure. In this embodiment, the connecting parts 144, 146 are respectively connected to the two ends of the primary sliding part 142, and the connecting parts 144, 146 each extend roughly in the predetermined direction Z1. The secondary sliding part 148 is generally disposed on the monitoring plane MP2, extending in the predetermined direction X1, and two ends of which respectively connected to the connecting parts 144, 146. Therefore, the secondary sliding part 148 as well as the connecting parts 144, 146 are also driven to simultaneously slide along the sliding track 132 while the primary sliding part 142 is driven by the moving part 152.

An image capture apparatus 204 is installed to the secondary sliding part 148. And thus, the image capture apparatus 204 can capture images of the work platform 104 on the work plane WP2 from different positions on the monitoring plane MP2 while the secondary sliding part 148 is driven by the moving part 152 to slide forwardly and backwardly in the predetermined direction Y1. In this embodiment, the image capture apparatuses 202, 204 are, for example, Charge-Coupled Device (CCD) cameras, Complementary Metal-Oxide Semiconductor (CMOS) cameras or other types of image/video recording devices.

In some other embodiments, the monitoring platform 106 further includes another sliding track 134 functioning as a secondary sliding track. The sliding track 134 is also disposed on the monitoring plane MP1, extending in the predetermined direction Y1, and supported by the first supporting rods 112, 114, the ones from the first supporting rods that are not connected to the sliding track 132. Similarly, the primary sliding part 142 can slide along the sliding track 134; in other words, while the primary sliding part 142 a first end of which is driven by the moving part 152 of the sliding track 132 to slide forwardly and backwardly in the predetermined direction Y1, simultaneously a second end of the primary sliding part 142 also slides forwardly and backwardly in the predetermined direction Y1 along the sliding track 134.

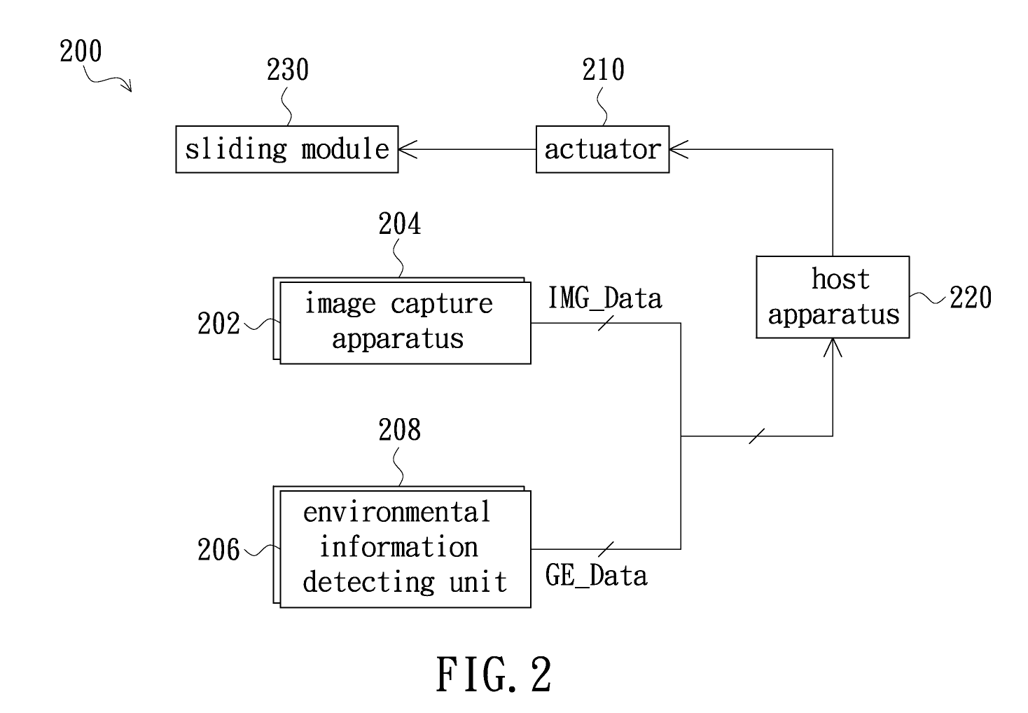

FIG. 2 is a block view of a monitoring system, which is a combination of the mechanical part of the monitoring platform 106 and the electrical part of the planting bed 100, in accordance with an embodiment of the present invention. Please refer to FIGS. 1, 2, the monitoring system 200 includes an image capture module (exemplarily constituted by the image capture apparatuses 202, 204), an actuator 210 and a sliding module 230, which is constituted by the sliding structure 140 and the sliding tracks 132, 134. The actuator 210, implemented with a motor and electrically connected to the sliding module 230, is configured to drive the moving part 152 of the sliding track 132 to move forwardly and backwardly in the predetermined direction Y1.

Additionally, the monitoring system 200 further includes a host apparatus 220, such as a desktop computer, a portable computer or a smart handheld device, electrically connected to the actuator 210. Through the host apparatus 220, workers/or operators can control the actuator 210 to drive the sliding structure 140, as well as the primary sliding part 142 and the secondary sliding part 148, to slide to an image capturing position for the image capture apparatuses 202, 204 to capture images.

In addition, the host apparatus 220 is signal connected to the image capture apparatuses 202, 204. In some embodiments, the connections between the host apparatus 220 and the image capture apparatuses 202, 204 are implemented with a cable transmission interface; or implemented with a wireless transmission interface in some other embodiments. While the image capture apparatuses 202, 204 capture images of the planting beds on the work planes WP1, WP2, respectively, so as to generate and transmit a plurality of image data IMG_Data to the host apparatus 200, workers/or operators can analyze the image data IMG_Data through the host apparatus 200. In other words, through an analysis on the image data IMG_Data, workers/or operators can obtain the plant indicators, such as the projected area of leaves, the height and the volume of plants on the work planes WP1, WP2 so as to analyze the growing cycle of the plants according to these obtained plant indicators.

In addition, the monitoring system 200 further includes at least one environmental information detecting unit. The monitoring system 200 according to this embodiment shown in FIG. 2 is exemplified by being constituted by two environmental information detecting units 206, 208, which are installed to the primary sliding part 142 and the secondary sliding part 148, respectively. Thus, while the image capture apparatuses 202, 204 capture images of the work platforms 102, 104, respectively, the environmental information detecting unit 206, 208 (for example, humidity detectors, carbon dioxide detectors, light detectors or thermometers) are configured to collect growth environmental information (for example, humidity, carbon dioxide concentration, lightness or temperature) associated with the work platforms 102, 104. In addition, the environmental information detecting units 206, 208 are configured to be signal connected to the host apparatus 200 so as to transmit growth environmental data GE_Data, derived from the collected growth environmental information, to the host apparatus 200. And thus, through an analysis, performed by the host apparatus 220, on the impacts of the growth environmental information (for example, humidity, carbon dioxide concentration, lightness, temperature or nutrient solution) on the work platforms 102, 104, workers/or operators can conclude suitable growth conditions for the plants on the planting bed.

In summary, because an image capture apparatus is installed to a sliding structure capable of sliding forwardly and backwardly in a predetermined direction, so a planting bed can be monitored completely through adopting one image capture apparatus only in the present invention. In addition, different types of environmental information associated with the planting bed can be collected due to the sliding structure is further equipped with an environmental information detecting unit.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A monitoring platform adapted to use with a planting bed, the planting bed being constituted by a work platform disposed on a work plane and for supporting a plurality of plants thereon, the monitoring platform comprising:
a first sliding track disposed on a monitoring plane and extending in a first predetermined direction, wherein the monitoring plane and the work plane are parallel to each other in a first visible range and have a first predetermined distance therebetween;
a sliding structure extending in a second predetermined direction and a first end thereof disposed on the first sliding track, wherein the sliding structure through the first end thereof slides along the first sliding track;
an actuator for driving the sliding structure to slide along the first sliding track; and
an image capture apparatus installed to the sliding structure for capturing a plurality of images at different positions on the work platform while the sliding structure is being driven to slide.

2. The monitoring platform according to claim 1, wherein the first sliding track is an electrical sliding track and comprises a moving part, the moving part is driven by the actuator to slide forwardly and backwardly in the first predetermined direction.

3. The monitoring platform according to claim 2, wherein the sliding structure comprises:
a primary sliding part connected to the moving part, extending in the second predetermined direction and to which the image capture apparatus being installed.

4. The monitoring platform according to claim 3, wherein the sliding structure further comprises:
a first and a second connecting parts extending in a third predetermined direction and connected to two ends of the primary sliding part, respectively; and
a secondary sliding part extending in the second predetermined direction and two ends thereof connected to the first and the second connecting parts, respectively,
wherein the secondary sliding part is disposed on a second monitoring plane, the first and the second monitoring planes have a second predetermined distance therebetween, and the first and the second monitoring planes are parallel to each other in a second visible range.

5. The monitoring platform according to claim 4, wherein the first predetermined distance is equal to the second predetermined distance.

6. The monitoring platform according to claim 1, further comprising a second sliding track disposed on the monitoring plane and extending in the first predetermined direction for supporting a second end of the sliding structure and thereby the sliding structure capable of sliding forwardly and backwardly along the first and the second sliding tracks.

7. The monitoring platform according to claim 1, further comprising an environmental information detecting unit installed to the sliding structure for collecting growing environmental information of the planting bed.

8. A structure of a planting bed, comprising:
at least a first work platform disposed on a first work plane for supporting a plurality of plants;
a plurality of first supporting rods each extending in a first predetermined direction;
a plurality of second supporting rods disposed on the first work plane and around the first work platform so as to support the first work platform on the first work plane, and the second supporting rods each being connected to two adjacent first supporting rods; and
a monitoring platform supported fixedly by the first supporting rods and comprising:
a first sliding track disposed on a first monitoring plane, extending in a second predetermined direction and supported fixedly by a portion of the first supporting rods, wherein the first monitoring plane and the work plane are parallel to each other in a visible range and have a first predetermined distance therebetween;
a sliding structure extending in a third predetermined direction and a first end thereof disposed on the first sliding track, wherein the sliding structure through the first end thereof slides along the first sliding track; and
an image capture apparatus installed to the sliding structure for capturing a plurality of images at different positions on the work platform while the sliding structure is being driven to slide.

9. The structure according to claim 8, wherein the first, the second and the third predetermined directions are generally perpendicular to each other.

10. The structure according to claim 8, wherein the first sliding track is an electrical sliding track and comprises a moving part for connecting to and driving the sliding structure to slide forwardly and backwardly in the third predetermined direction.

11. The structure according to claim 10, wherein the sliding structure comprises:
a primary sliding part connected to the moving part, extending in the third predetermined direction and to which the image capture apparatus being installed.

12. The structure according to claim 11, wherein the sliding structure further comprises:
a first and a second connecting parts extending in the first predetermined direction and connected to two ends of the primary sliding part, respectively; and
a secondary sliding part extending in the second predetermined direction and two ends thereof connected to the first and the second connecting parts, respectively,
wherein the secondary sliding part is disposed on a second monitoring plane, the first and the second monitoring planes are parallel to each other and have a second predetermined distance therebetween.

13. The structure according to claim 8, wherein the monitoring platform further comprises:
a second sliding track extending to the second determined direction, supported by the first supporting rods which are not connected to the first sliding track, and thereon the sliding structure sliding.

14. The structure according to claim 8, wherein each two adjacent first supporting rods have a same distance therebetween.

15. The structure according to claim 8, wherein each two adjacent first supporting rods have a different distance therebetween.

16. The structure according to claim 8, further comprising an environmental information detecting unit installed to the sliding structure for collecting growing environmental information of the planting bed.

17. A monitoring system adapted to use with a planting bed, the planting bed being constituted by a work platform disposed on a work plane and for supporting a plurality of plants thereon, the monitoring system comprising:
a supporting bracket disposed on the work platform for defining a monitoring plane opposite to the work plane, wherein the monitoring and work planes are parallel to each other in a visible range and have a predetermined distance therebetween;
a sliding module supported by the supporting bracket and comprising a sliding structure;
an actuator electrically connected to the sliding module for driving the sliding structure to slide forwardly and backwardly on the monitoring plane in a predetermined direction; and
an image capture apparatus installed to the sliding structure for capturing a plurality of images of the work platform from different positions on the monitoring plane while the sliding structure is driven by the actuator to slide in the predetermined direction.

18. The monitoring system according to claim 17, wherein the actuator is implemented with a motor.

19. The monitoring system according to claim 17, further comprising:
an environmental information detecting unit installed to the sliding module for collecting growth environmental information associated with the planting bed.

20. The monitoring system according to claim 17, wherein the environment information detecting unit comprises at least one of a humidity detector, a carbon dioxide detector, a light detector and a thermometer.

21. The monitoring system according to claim 19, further comprising:
a host apparatus signal connected to the image capture apparatus and the environmental information detecting unit for monitoring the planting bed based on the images captured by the image capture apparatus and the growth environmental information collected by the environmental information detecting unit.
